(19) United States
(12) Patent Application Publication
(10) Pub. No.: US 2007/0105236 A1
(43) Pub. Date: May 10, 2007

(54) Method of examining blood type and apparatus for examining blood type using the method

(75) Inventors: Jun-Keun Chang, Seoul (KR); Chae-Seung Lim, Kyunggi-Do (KR); Yong-Ku Lee, Seoul (KR)

Correspondence Address: BROWDY AND NEIMARK, P.L.L.C.;624 NINTH STREET, NW, SUITE 300, WASHINGTON, DC, 20001-5303, US

(73) Assignee: Digital Bio Technology, Seoul (KR)

(21) Appl. No.: 10/580,541

(22) PCT Filed: Nov. 29, 2003
(86) PCT No.: PCT/KR03/02611

§ 371 Date: May 26, 2006

(51) Int. Cl. G01N 1/18

(52) U.S. Cl. 436/177

(57) ABSTRACT

A method of examining blood type and an apparatus for examining blood type using the method are presented. According to the method, the blood type is examined once the blood is injected into the apparatus, and the result of examination is kept safely. The method comprises introducing the reagents into the plural reagent chambers respectively; flowing the blood into each of reagent chambers and mixing them with the reagents; filtering the mixture of blood; and flowing the mixture of blood which passed the filters-into the reading channels. The introduced blood is passed the micro channels and reacted with the reagents, and the results are obtained from filtering the mixture of blood. Thus, even small quantity of blood may be examined easily and clearly. Further, the results of examination are easily read and kept. The apparatus may be carried out and used with convenience.

### TECHNICAL FIELD

The invention relates to a method of examining blood type and an apparatus for examining blood type. More specifically, the invention relates to an apparatus that can examine blood types conveniently by just one operation by use of micro-channels and micro-filters.

### BACKGROUND ART

In 1900, Karl Landsteiner asserted that the reason for resulting in severe side effects on a blood transfusion when the blood of one person was transfused to other persons was that erythrocyte was hemolyzed by isoagglutinin. Since then, 23 kinds of blood type groups, for example MNS, P, Rh, Lutheran, Kell, Lewis, as well as ABO blood type are classified. Such classification is a base for avoiding side effects of hemolysis on a blood transfusion which is required in a surgical operation or in war. The existence of an antibody for an antigen of erythrocyte is a major factor determining the success of a blood transfusion.

For this reason, ABO-type blood examination, Rh-type blood examination, antigen screen examination etc. which are mandatory items for examining blood have been performed in conventional physical examinations at hospitals. However, the conventional examination method used in hospitals comprises manual operations that prepare an antigen sample on a glass slide, and examine cohesion response one by one by dropping blood at the antigen. If any apparatus is used in the method, the examination apparatus is expensive and imported one.

In the method of using a glass slide, the examination should be performed one by one by hand. Because the result of the examination can not be conserved for a long time after the examination, a blood type should be obtained through each examination. In addition, there are problems such as troubles and non-hygiene that the slide should washed for reuse after writing the result of the examination. In case of processing many samples, there are possibilities of writing errors when writing the results of the examinations. As the examiners should wash the slides, they are in danger of being exposed to the blood of patients. Also, there is a problem that the results of the examinations can be incorrect by incomplete washing. Furthermore, as the examination result of the method using glass slides depends on the judgement of examiners, it has fault that the objectivity for the examination results can be lowered remarkably.

Besides, although there are expensive examination apparatus in the configuration of chip, these apparatus should use extra expensive devices such as chip-dedicated incubators, a centrifuge, a sampler, and a reader to use the blood examination chip. Thus, the use of such apparatus causes not only a spatial problem but also an economical burden to the examiners.

As such, the conventional blood examination method and apparatus have problems for example, a burden of purchasing, a difficulty of using and keeping, and lacks of objectivity in the examination. Especially, examiners should obtain more than a certain amount of blood even in case for examining new-born babies or infants the blood of which is not easy to obtain.

### DISCLOSURE OF INVENTION

The object of the invention is to provide a simple and cheap blood-type examination method and apparatus that can get sufficient results even from a small amount of blood.

Another object of the invention is to provide a blood-type examination method and apparatus that can guarantee the objectivity of the blood-type examination and save the examination result.

The other object of the invention is to provide a blood-type examination apparatus that can be produced in convenience with low cost in large quantities.

To achieve the above objects, according to a preferred embodiment of the invention, the invention relates to the method that examines blood types by having the same amount of blood sample react with reagent. The method according to the invention comprises steps of: introducing one or more reagents into each of the plural reagent storage chambers; flowing the blood sample into each of reagent storage chambers and mixing the blood sample with the reagents; filtering the mixture or the agglutination product of the blood sample and the reagents using micro filter; and flowing the mixture or the agglutination product which passed the micro filters into the reading channels each of which is connected to the micro filter.

The invention is based on characteristics that the injected blood sample forms different mixture states or different agglutination product states depending on a specified reagent. A certain blood type can be determined by determining whether the mixture or the agglutination product of the reagents and the blood sample is filtered and which reagents makes the mixture or the agglutination product passed the filter.

When determining ABO blood type according to an ordinary embodiment, antigens corresponding to A-type and B-type are allocated in the reagent storage chamber, and then blood sample is introduced into each of the plural reagent chambers. The antigen-antibody reaction occurs, and different states may be formed. The introduced A-type blood sample can cause the antigen-antibody reaction with antigen A, not with antigen B. As a result, the blood subjected to an agglutination reaction with the antigen A can't pass the micro-filter. On the other hand, the blood in the other reagent storage chamber which is mixed with the antigen B can be passed through the micro filter. According to the result whether the mixture is passed or not, the examiner can see that the introduced blood sample is A-type. Such a method can be applied for B-type, AB-type, and 0-type.

Besides ABO blood type examination, the examiner can read a differently defined blood type such as the Rh blood-type by selecting reagents corresponding to blood.

According to a preferred embodiment, the method of the invention further comprises the steps of introducing the blood sample into the blood injection chamber, and flowing the blood sample located in the blood injection chamber into plural micro-channels. The blood sample injected into the blood injection chamber flows into the micro-channels connected with the blood injection chamber by a capillary phenomenon. Thus, the blood sample is introduced into the reagent storage chambers containing each reagent. By forming one blood injection chamber and forming micro-channels connecting the blood injection chamber with each reagent storage chamber, the examiner can almost simultaneously introduce the same amount of blood into plural reagent storage chambers by just one injection of blood sample, and can minimize the amount of blood required by properly distributing a small amount of blood.

According to a preferred embodiment, the method of the invention can make it easy to read the type of bloodpassing through reading channels by forming reading chamber in the reading channels. Circular reading chambers having a broader diameter than the width of the reading channels in the reading channel. By forming the reading window on the reading chamber, it is easy to read from the outside.

It is preferable to form the first blood resistance part between the reagent storage chamber and the micro-filter so that the reagent in the reagent storage chamber may not flow into the micro filter before it is mixed with blood. More concretely, by forming the first blood resistance part between the reagent storage chamber and the micro-filter and performing hydrophobic process on the parts of the inner surface of the first blood resistance, it is possible to prevent the reagent from not staying in the reagent storage chamber and from flowing into the filter. By performing the hydrophobic process on the parts of the inner surface of the micro-channel, an aqueous solution or any other fluids cannot easily pass through the hydrophobic processed area. Mainly, by performing chemical process on the wall of the channels, it can have hydrophobic characteristics.

Such a hydrophobic process can apply for forming the second blood resistance part at the end of the reading channels. To determine whether or not the blood mixture or agglutination product with the reagent pass through the filter, it is preferable for the blood mixture or agglutination product to stay on the reading channel. Particularly, when the blood is inhaled by forming low pressure at the end of the reading channel, the second blood resistance part makes it possible to prevent the blood mixture or agglutination product from being discharged by the inhalation force.

In addition, instead of forming the first resistance channel and the second blood resistance part by the hydrophobic processing, it is possible to slow the velocity of blood by raising resistance of the micro-channel, or closing the inhaling hole connected with the end of the reading channel

For example, by forming the channel width of micro-channel narrow, or forming space between filter poles at the micro-filter, which will be said later, the resistance of the micro-channels can be raised. As such, when the resistance of the micro-channels is high, the speed of fluid get lower. Thus, enough time can be provided for mixing and reacting the reagent in the reagent storage chamber with blood. Also, when the blood reaches the reagent storage chamber after introducing the blood into the blood injection chamber, the blood can be stayed in the reagent storage chamber by closing the inhaling hole formed at the end of the reading channel.

Also, to stay the blood mixture or agglutination product with regent in the reading channel or the reading chamber, it is possible to raise the resistance of the reading channel, or to close the inhaling hole connected with the end of the reading channel.

According to another embodiment of the invention, the blood type examining apparatus comprises the blood injection chamber, plural micro-channels the end of which are connected with the blood injection chamber, plural reagent storage chamber each of which is connected with another end of the micro-channel, plural micro-filters each of which is connected with the reagent storage chamber, and plural reading channels connected with each micro-filter.

The micro-channel can be one in a shape of a straight or curved line connecting the blood injection chamber with each reagent storage chamber. It can also be a circuit comprising micro-channels branched from a micro injection channel and connected with plural reagent storage chambers.

The micro-filter to filter mixture or agglutination product of the blood sample and the reagents is connected with the reagent storage chamber.

The micro-filter comprises the filter chamber and plural filter poles formed in the filter chamber. The filter poles may be allocated close together and parallel with direction of fluid passing through the filter to form plural holes. Thus, particles with the size of which can pass though between the filter poles may pass the filter. The filter includes a filter chamber and plural filter poles. Various filter pole structure can be used to pass through only a certain size of contents.

The first blood resistance part may be formed between the reagent storage chamber and the micro-filter. The second blood resistance part may be preferably formed adjacent to the end of the reading channel. The blood resistance part prevents the fluid from leaking by temporally interfering the flow of fluid in channels. It also provides so many times that the fluid can be mixed, and temporally store the fluid in order to easily read the fluid which has passed through the filter.

According to the preferred embodiment, if hydrophobic process is performed at a part on the wall of the channel wherein the fluid flows, the fluid passing through the hydrophobic processed channel is interfered. The first blood resistance part is located between the reagent storage chamber and the micro-filters. The first blood resistance part includes the first resistance channel and the first hydrophobic processed surface part. It prevents the reagent stored in the reagent storage chamber from flowing into the micro-filters before the reagent is mixed with blood. The first blood resistance part provides enough time to react by interfering flow of the mixture of the reagent and blood.

The second blood resistance part is located at the end of reading channels. If reading chambers are formed, it is located at the opposite side of the first blood resistance part, and the reading channel is located between them. The second blood resistance part includes the second hydrophobic surface processed part which is formed at least one of inner surface of the reading channel. It is easy to read the result because the second blood resistance part temporally blocks the end of the reading channel to retain the fluid.

Also, instead of forming the first resistance channel and the second blood resistance part as above mentioned, it is possible to slow the speed of blood or to stagnate blood by raising channel resistance of micro-channel or reading channel, or closing the inhaling hole connected with the end of the reading channel.

The inhaling hole is formed at the end of the reading channel. The inhaling hole can be formed at each of the end of the channels respectively. One inhaling hole is connected with plural reading channel and provides inhaling power for blood and mixture of blood and reagent to easily pass through channel. Otherwise, it can be also possible for each reading channel to have one inhaling hole.

In the blood type examining apparatus according to the invention, the reading parts comprising micro-channels, the reagent storage chamber, micro-filter, the reading channels, etc. are connected with each other in order that injected blood can pass through sequently. The reading parts are equipped plurally. The plural reading parts can be allocated randomly in various configuration. For example, it can be allocated parallel with each other, symmetrically or radially with respect to the blood injection chamber.

The blood type examining apparatus according to the invention can be made by use of any materials with transparency. Preferably, glass or plastic, for example, polycarbonate(PC), polymethylmethacrylate(PMMA), polyethylene(PE), polyethyleneterephthalate(PET), polystyrol(PS), polytetrafluoroethylene(TEFLON), polyvinylchloride(PVC), or polydimethylsiloxane(PDMS), etc.

### BRIEF DESCRIPTION OF DRAWINGS

FIG. 1 is a brief diagram for illustrating the blood examining method and apparatus according to the first-embodiment-of-the-invention.

FIG. 2 is a brief diagram for illustrating the blood examining method and apparatus according to the second embodiment of the invention.

FIG. 3 is a perspective view of the blood examining apparatus according to the third embodiment of the invention.

FIG. 4 is a plane view of the blood examining apparatus of FIG. 3.

FIG. 5 is a cross sectional view taken along line I-I of FIG. 4.

FIG. 6 is a partially magnifying plane view for illustrating the blood type examining apparatus of FIG. 4.

FIG. 7 is a decomposition diagram of the blood examining apparatus of FIG. 4.

FIGS. 8a and 8b are partially magnifying plane view for other embodiments of micro-filter.

FIG. 9 is a plane view of the blood type examining apparatus according to the fourth embodiment of the invention.

FIG. 10 is a plane view of the blood type examining apparatus according to the fifth embodiment of the invention.

FIG. 11 is a decomposition diagram of the blood examining apparatus of FIG. 10.

### DECRIPTION OF REFERENCE NUMERALS FOR IMPORTANT PART OF THE DRAWINGS

300: blood type examining apparatus

305: base plate 310: chip plate

320: blood injection chamber

330: reagent storage chamber

340: micro-filter

350: reading channel

380 : reading chamber 390: inhaling hole

### BEST MODE FOR CARRYING OUT THE INVENTION

Reference will now be made in detail to the present invention as illustrated in the accompanying drawings. However, the invention cannot be confined by the following embodiment.

Embodiment 1

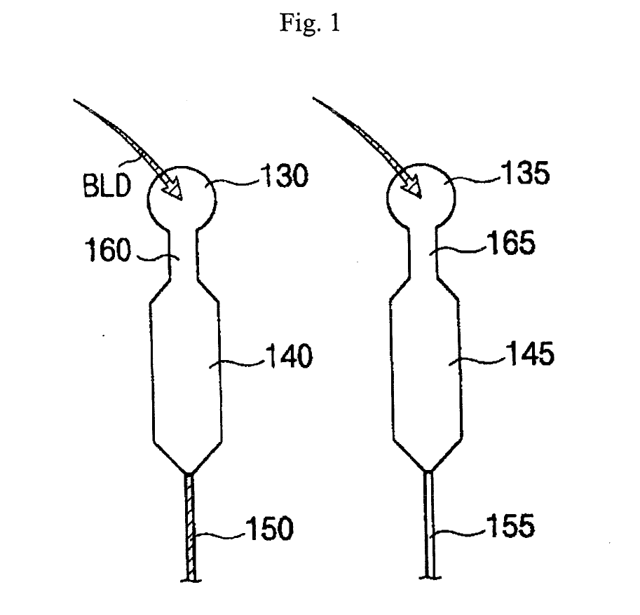

FIG. 1 is a brief diagram for illustrating the blood examining method and apparatus according to the first embodiment of the invention.

With reference to FIG. 1, the blood type examining apparatus according to the first embodiment comprises two reagent storage chambers(130, 135), micro-filters (140,145) connected with each reagent storage chamber(130,135), and the reading channels(150, 155) connected with another end of the micro-filters(140, 145).

Sampled blood(BLD) from a person is inserted into the reagent storage chamber (130, 135) directly or through an injection means such as a syringe. In the reagent storage chamber(130,135), the reagents which makes it possible to read the blood type, A antigen and B antigen are stored in different reagent storage chambers respectively. As the blood(BLD) is mixed with the A antigen or the B antigen, antigen-antibody reaction can occur. When agglutination reaction occurs, the agglutinated blood mixture can not pass through filter. On the other hand, blood mixture with no agglutination reaction can pass through the filter. Thus, blood type may be determined through reading channels.

The first blood resistance part(160, 165) is formed between the reagent storage chamber(130, 135) and the micro-filer(140, 145). The first blood resistance part(160, 165) includes the first resistance channel and the first hydrophobic surface processed part formed at the bottom of the first resistance channel. The first hydrophobic surface-processed part prevents the reagent stored in the reagent storage chamber(130, 135) from flowing in the micro-filter(140, 145) before the reagent is mixed with blood. After the reagents are mixed with blood, the reagent storage chamber can hold the blood mixture for providing enough time to mix with each other.

After enough time has passed, in order that the mixture or agglutination products contained in each reagent storage chamber(130, 135) pass through the first blood resistance part(160, 165), and flow into the micro-filters(140, 145), the examining apparatus may be leaned or the fluid may be inhaled by connecting the end of reading channel(150, 155) with the inhaling means.

Although A antigen and B antigen are used as the reagent to detect ABO type of blood in this embodiment, it is not confined to that, and any examining method using other ABO type blood examining method or other kinds of blood type examining method can be applied if it can determined the blood type from the result of mixture by use of filter.

Embodiment 2

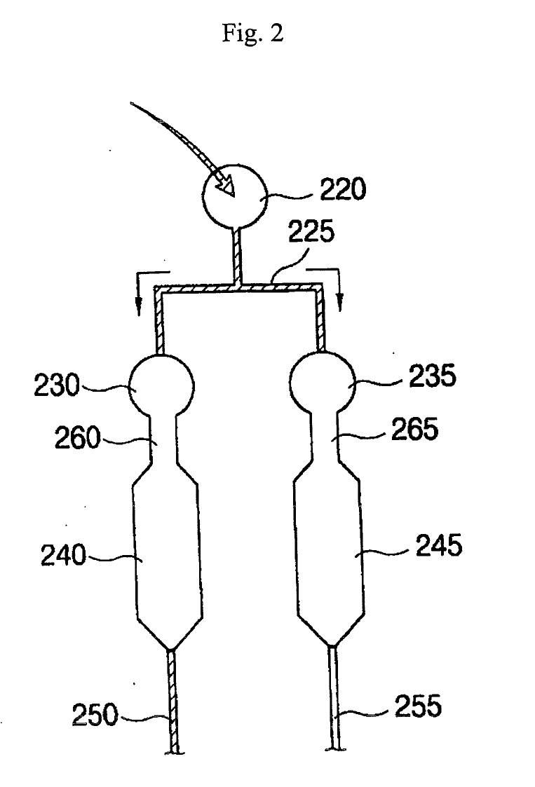

FIG. 2 is a brief diagram for illustrating the blood examining method and apparatus according to the second embodiment of the invention.

According to FIG. 2, the blood type examining apparatus comprises blood injection chamber(220), micro channel(225) one end of which is connected to the blood injection chamber(220) and the other end of which is branched in two, two reagent storage chamber(230, 235) connected to the end of the branched micro-channel (225) respectively, two micro-filers(240,245) connected to each reagent storage chamber(230,235), and the reading channel(250,255) connected to another end of micro-filters(240,245).

According to the embodiment, the blood injection chamber(220) and the reagent storage chamber(230,235) are formed in a shape of a cylindrical chamber. The micro-channel(225) or the micro-filters(240,245) are connected to the bottom of each chamber(220,230,235).

Similar to the embodiment 1, blood(BLD) sample collected from a person can be injected to the blood injection chamber(220) directly or through an injection means, such as, a syringe, etc. At the reagent storage chamber(130,135), the reagent which makes it possible to read the blood type, A antigen and B antigen are stored in different reagent storage chamber. As blood(BLD) is automatically divided and introduced at the same time with the same amount, and mixed with the A antigen or the B antigen, the antigen-antibody reaction can occur. When agglutination reaction occur, the agglutinated blood mixture cannot pass through the filter. On the other hand, blood mixture with no agglutination reaction can pass through the filter. Thus, blood type can be determined through reading channels. Of course, it is possible to control not to pass the blood mixture with agglutination reaction through the filter by adjusting the size of filter or the density of the filter poles in the micro filter(240,245).

For example, under the condition that A antigen is located in left reagent storage chamber(230) and that B antigen is located in right reagent storage chamber(235), if B type blood is injected into the blood injection chamber, then it will cause agglutination reaction between the blood and the B antigen in the right reagent storage chamber(235). However, agglutination reaction will not occur between blood and the A antigen in the left reagent storage chamber(230). Therefore, the blood mixed with A antigen can pass through the left micro-filter(240) and the type of blood can be read through the reading channel(250) The blood mixed with B antigen and subjected to agglutination reaction cannot pass through the right micro-filter(245), and cannot be seen read through the reading channel(255).

The first blood resistance part(260,265) are formed between the reagent storage chamber(230,235) and the micro-filter(240,245). The first blood resistance part(260,265) comprises the first resistance channel and the first hydrophobic surface-processed part formed at the bottom of the first resistance channel. The first hydrophobic surface-processed part prevents the reagent stored in the reagent storage chamber(230, 235) from flowing in the micro-filters(240, 245) before the reagent is mixed with blood. After the reagents are mixed with blood, the reagent storage chamber can hold the blood mixture for providing enough time to mix with each other.

After enough time has passed, in order that the mixture or agglutination product contained in each reagent storage chamber(230, 235) pass through the first blood resistance part(260, 265), and flow into the micro-filters(240, 245), the examining apparatus may be leaned or the fluid may be inhaled by connecting the end of reading channel(250, 255) with the inhaling means.

Although A antigen and B antigen are used as the reagent to detect ABO type of blood in this embodiment, it is not confined to that, and any examining method using other ABO type blood examining method or other kinds of blood type examining method can be applied if it can determined the blood type from the result of mixture by use of filter.

Embodiment 3

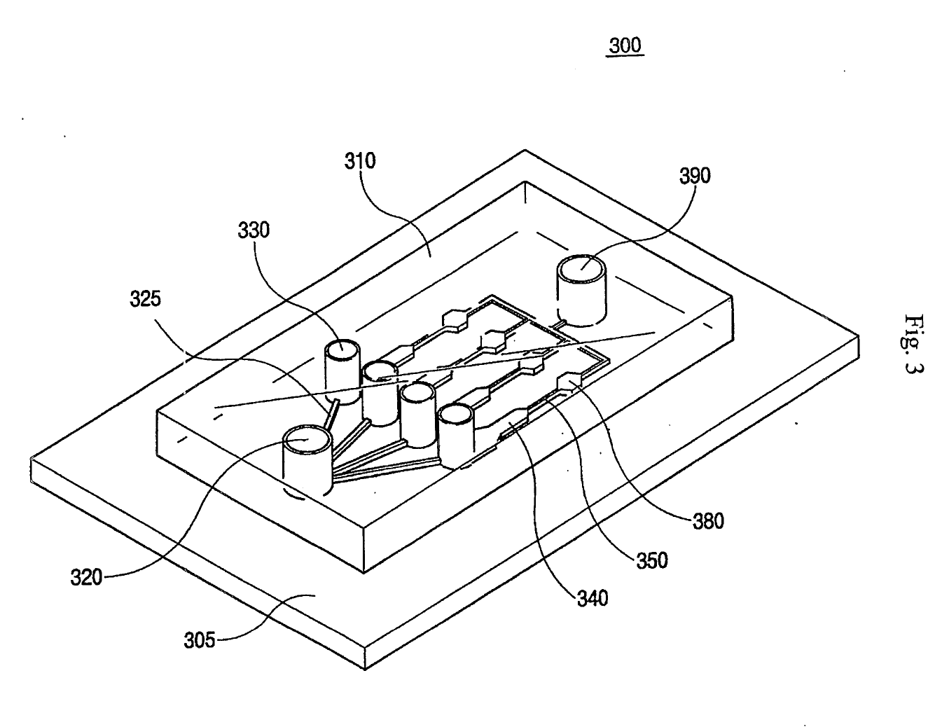

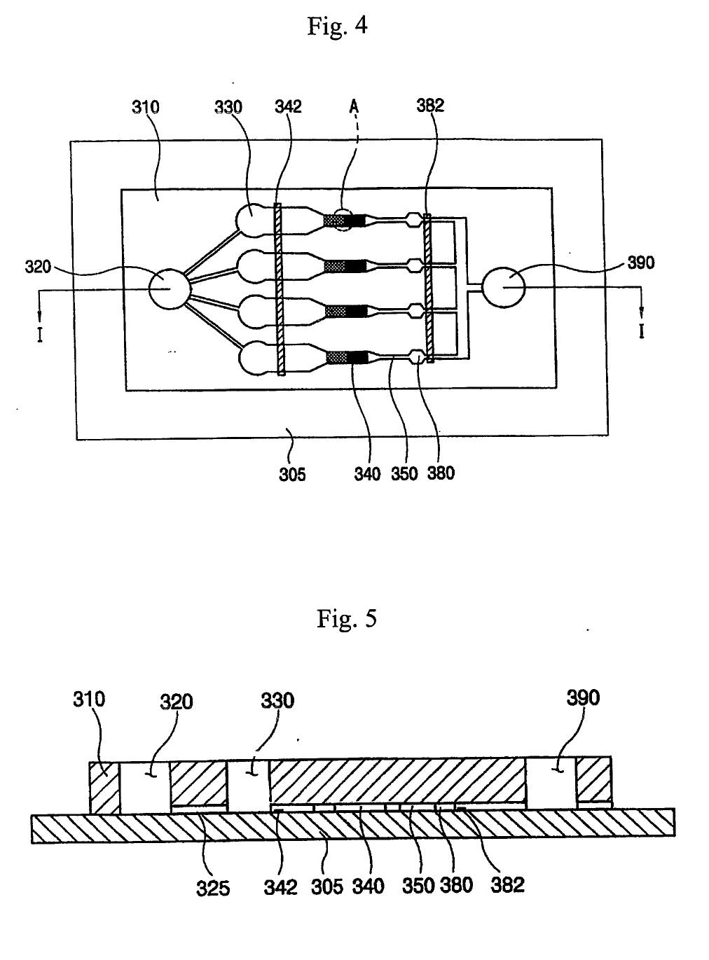

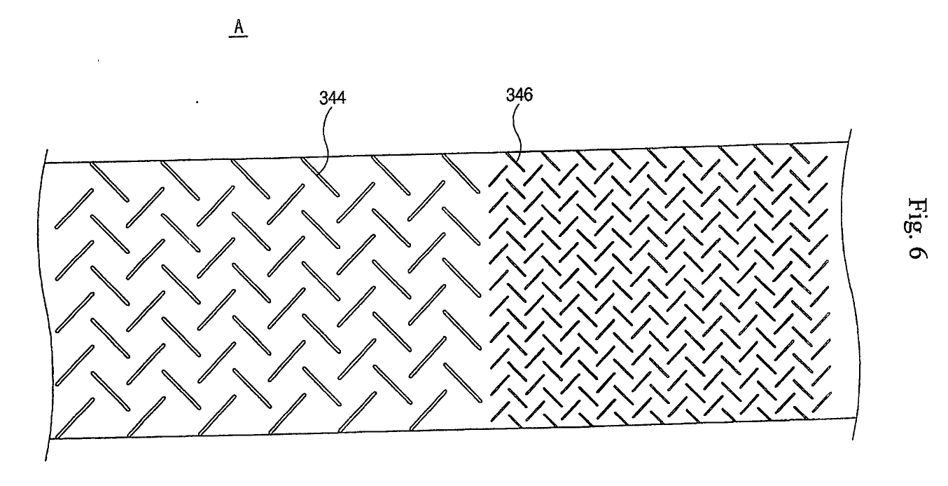

FIG. 3 is a perspective view of the blood examining apparatus according to the third embodiment of the invention. FIG. 4 is a plane view of the blood examining apparatus of FIG. 3. FIG. 5 is a cross sectional view taken along line I-I of FIG. 4.

With reference to FIG. 3 through FIG. 5, the blood examining apparatus(300) according to the embodiment 3 comprises a base plate(305), a chip plate(310) located at upper side of the base plate(305), a blood injection chamber(320) formed at the left center of the chip plate(310), 4 reagent storage chambers(330) formed on the chip plate(310) in a line adjacent to the blond injection chamber(320, 4 micro-channels (325) connecting the blood injection chamber(320) with each reagent storage chamber(330), the first blood resistance part connected with each reagent storage chamber(330), 4 micro filters(340) connected with each first blood resistance part, 4 reading channels(350) connected with the end of each micro-filter(340), 4 reading chambers(380), which are located on the each reading channel(350) to form a reading windows, a inhaling hole connected with the end of the reading channel(350), and the second blood resistance part(382) located between the end of reading channels(350) and reading chambers(380).

In this embodiment, the base plate(304) is composed of hexahedral, transparent glass. The chip plate(3 10) composed of a polymer material is located on the base plate(305). The blood injection chamber(320), the micro-channel(325), the reagent storage chamber(330), the micro-filter(340), the reading channel(350), the reading chamber(380), and the inhaling hole(390) are formed at the bottom of the chip plate(310) contacting the base plate(305), and they are formed on the bottom of the chip plate(310) in intaglio by molding polymer material.

The polymer material composing the chip plate(310) may be plastics such as polymethylmethachrylate(PMMA), polycarbonate, polytetrafluoroethylene(TEFLON), polyvinylchloride(PVC), polydimethylsiloxane(PDMS) etc.

The blood injection chamber(320) is formed at the center, adjacent to the one end of the chip plate(310). The one end of micro-channel(325) is connected to the lower side of the blood injection chamber(320) and the other end of that is connected to each different reagent storage chamber(320) respectively. In this embodiment, anti-A, anti-B, and anti-D are stored in the reagent storage chamber(340) in about 2˜5 μl or less.

As about 10 μl or less of blood(BLD) is injected into the blood injection chamber(320), the blood is introduced into the reagent storage chamber(330) through the micro-channel(325) by an inhaling force or a capillary action. The blood is mixed or subjected to agglutination reaction with antigen stored in the reagent storage chamber. The blood reacts differently depending on its blood types.

After enough time to cause agglutination reaction has passed, the blood mixture or the agglutination product may be introduced into the micro-filter(340) by leaning the examining apparatus or by applying inhaling force through the inhaling hole(390) formed in the examining apparatus.

Similarly to the first embodiment and the second embodiment, the blood agglutination product which goes through the agglutination reaction can't pass through the micro-filter(340). On the other hand, the other blood mixture can pass through the micro-filter(340) and can be detected through the reading channel(350).

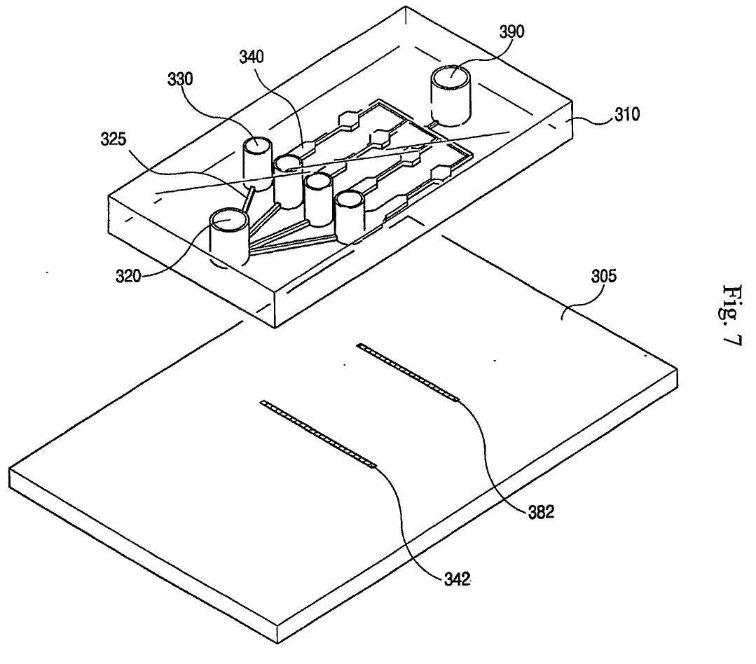

FIG. 6 is a partially magnifying plane view for illustrating the blood type examining apparatus of FIG. 4.

With reference to FIG. 6, the micro-filter according to this embodiment has two stages of filter layers. They comprises the first filter part(344) adjacent to the reagent storage chamber(330) with broad interval between filter structures, and the second filter part(346) with narrow interval between filter structures adjacent to the reading channel(350) side. According to the depicted first and the second filter parts(344, 346), plural filter poles are arrayed to form filter structure at each filter part(344, 346). The width is longer than its length in the cross-sectional view of the filter poles. The plural filter poles are allocated regularly to the first direction with even, spaced interval. Other plural filter poles adjacent to them are allocated regularly to the second direction, with even spaced interval. The second direction is crossed with the first direction. Thus, the plural filter poles are arrayed perpendicularly with each other in the shape of T.

According to this embodiment, the filter poles of the first filter part(344) are spaced by about 100 μm to the first direction having right 45° angle with respect to the fluid flowing direction. Other filter poles adjacent to them are spaced by about 100 μm to the second direction having left 45° angle with respect to the fluid flowing direction. The filter poles of the second filter part(346) are similarly arrayed to those of the second filter(344). However, the spaces between the filter poles is about 50 μm and the size of the filter pole is about ½ to those of the first filter part. The filter poles of the first and the second filter part(344,346) are formed through molding when the chip plate(310) is molded. The lower side of the filter pole is contacted to the base plate(305) to form poles in the filter chamber.

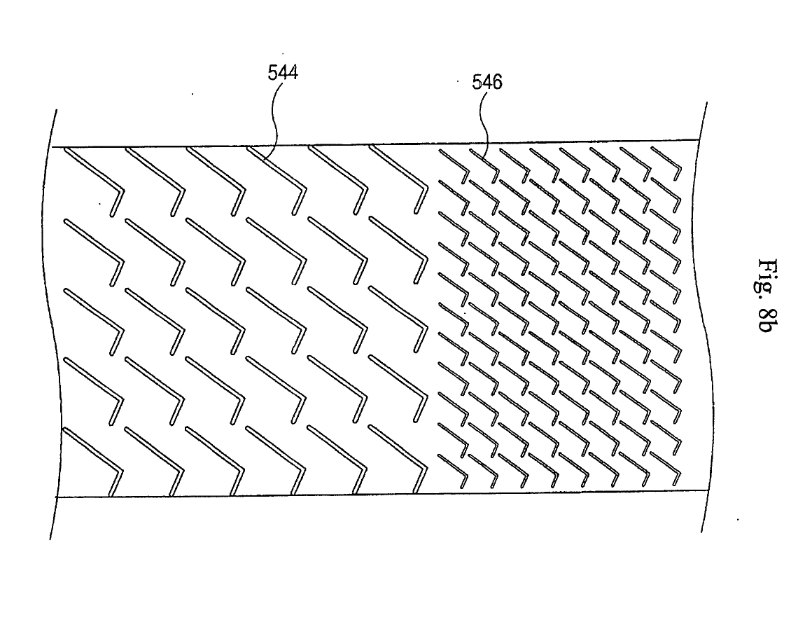

The shape and array of the filter poles can be variable according to designer's choice. FIG. 8a and FIG. 8b are partially magnifying plane view for other embodiments of micro-filter. The invention is not confined within the shape and array of the filter poles depicted in FIG. 6, FIG. 8a and FIG. 8b.

The first resistance part is formed between the reagent storage chamber(330) and the micro-filter(340). The first resistance part makes the reagent stored in the reagent storage chamber(330) or makes the contents which are reacted with blood in the chamber contained. The first blood resistance part according to this embodiment comprises the first resistance channel and the first hydrophobic surface-processed part(342) located on the base plate(305) in the crossway direction to the channel direction forming a hydrophobic surface at the lower surface of the first resistance channel. It prevents the reagent from flowing out before the reagent is mixed with blood or prevents the blood mixture from flowing into the filter before it reacts sufficiently.

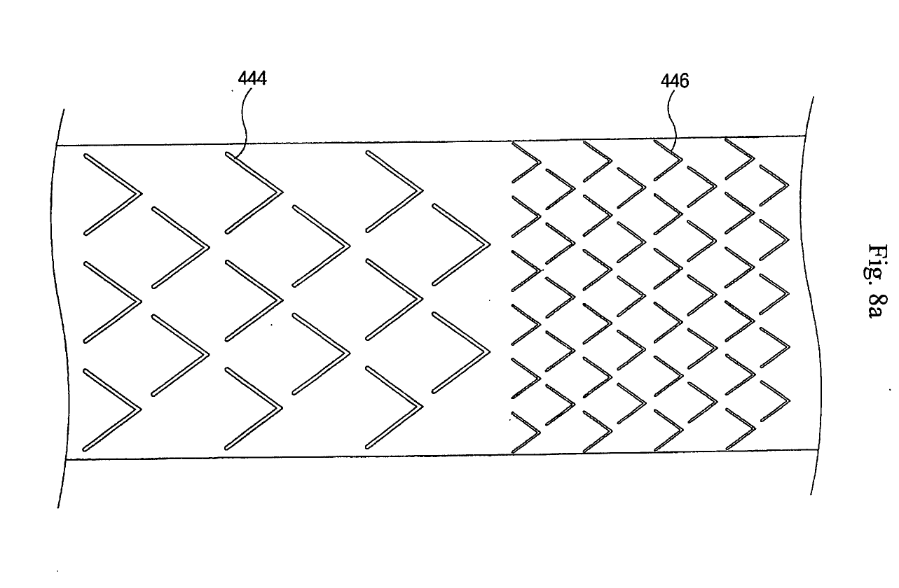

The FIG. 7 is a decomposition diagram of the blood examining apparatus of FIG. 4.

According to the FIG. 7, the first and the second hydrophobic surface-processed part(342, 382) are formed on a certain location of the base plate(305) before the blood injection chamber(320), the micro-channel(325), the reagent storage chamber(330), the micro-filter(340), etc is allocated on the base plate(305).

A variety of methods can be provided as methods for forming hydrophobic surfaces. According to this embodiment, octadecyltrichlorosilane : CH₃(CH₂)₁₇SiCl₃) (hereinafter “OTS”) is used for the hydrophobic process on the base plate(305) composed of glass. The method includes the following steps. Mixture solution of OTS with hexane in ratio of 1:200 is applied on the base plate(305). Hexane is washed with the mixture solution of hexane with methanol in ratio of 1 to 1. After washing the hexane, OTS layers is formed on the base plate(305) by having methanol dry by N₂ After forming photomask on the OTS layer, ultraviolet with 400 nm wave length is illuminated. Then the exposed part is hydrophilic and masked part is hydrophobic.

According to this embodiment, the first and the second hydrophobic surface-processed part(343, 382) are formed by use of the OTS as above mentioned. However, the invention is not confined to this embodiment, and one of various methods can be chosen for forming hydrophobic surfaces on the base plate.

After enough time(up to about 3 minutes) to mix the blood and the reagent has passed, the mixture or agglutination product of the blood and the reagent is passed through the first resistance part and introduced into the micro-filter(340) by leaning the examining apparatus or by applying inhaling force through the inhaling hole(390). The inhaling hole(390) is connected with the end of the reading channel(350). The inhaling force can be formed by connecting one inhaling hole(390) with a syringe or other inhaling apparatuses.

The blood mixture passing through the micro-filter(340) can be read through the reading channel(350). To make it easy to read the blood mixture, the reading chamber(380) is formed in the reading channel(350). It is further easy to read if the wide upper side of the reading chamber is transparent to form a reading window.

In order to make it easy to read, the second blood resistance part is formed between the reading chamber(380) and the end of the reading channel(350). The second blood resistance part includes the second hydrophobic surface-processed art(382) formed on the channel bottom of the reading channel(350). As the forming method of the second hydrophobic surface processed part(382) is identical with that of the first hydrophobic surface processed part(342), repeated explanation with respect to the second hydrophobic surface processed part is omitted.

The second blood resistance part contains the blood mixture in the reading chamber(380), and prevents the blood mixture from leaking through the end of the reading channel(350). The second blood resistance also prevents the blood mixture from passing through the reading channel and drafting back to other adjacent reading channel(350).

Embodiment 4

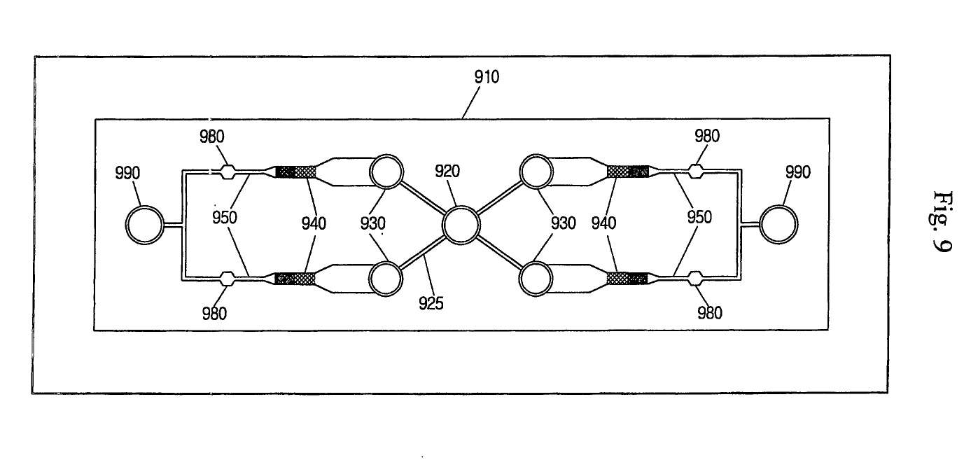

FIG. 9 is a plane view of the blood type examining apparatus according to the fourth embodiment of the invention. The chip plate(910) of the blood-type examining apparatus comprises the blood injection chamber(920) at the center, 4 reagent storage chamber(930) formed symmetrically in left and right side of the blood injection chamber(920), 4 micro-channel(925) connecting the blood injection chamber with each reagent storage chamber(930), 4 micro-filter(940) connected with each reagent storage chamber(930), 4 reading channels(950) connected with the end of each micro-filter (940), 4 reading chamber(980) located on each reading channel(950) and forming the reading window, and inhaling hole(990) connected with the end of two reading channels(950).

Ebodiment 5

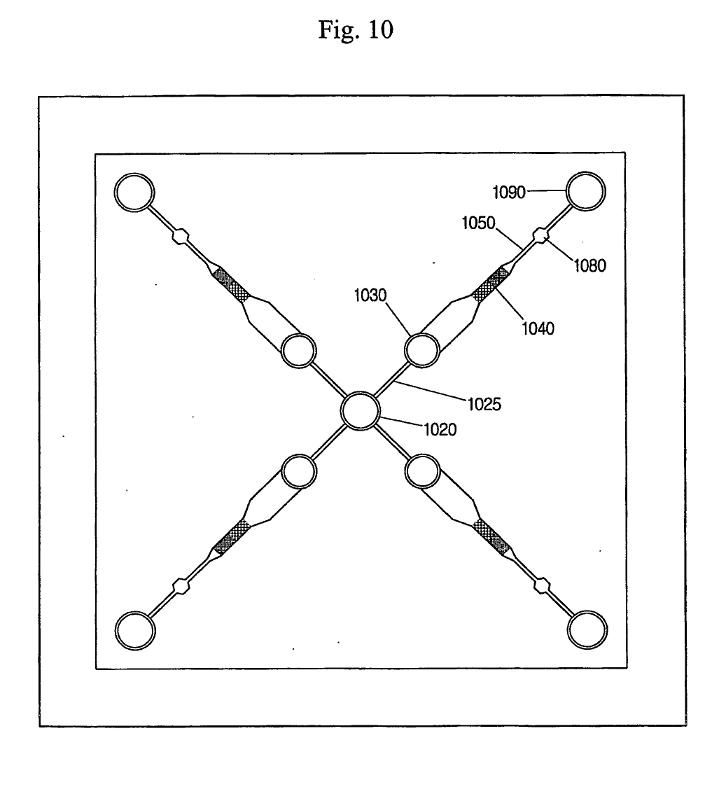

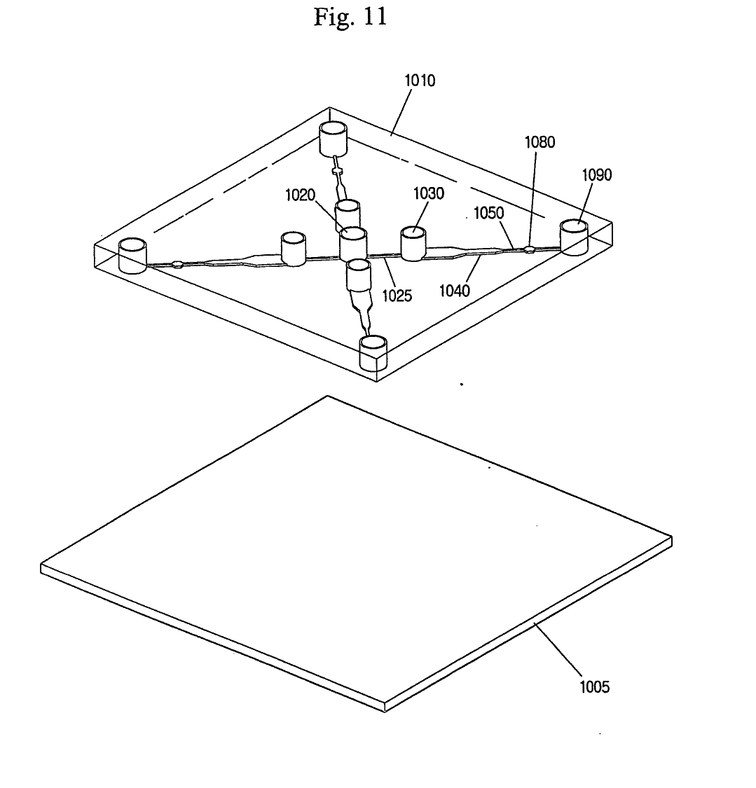

FIG. 10 and FIG. 11 are respectively plane view and perspective decomposition view of the blood type examining apparatus according to the fifth embodiment of the invention. In the examining apparatus, the reading part which comprises micro-channel (1025), reagent storage chamber(1030), micro-filter(1040), and reading channel(1050), etc. is allocated radially from the blood infection chamber(1020). The first and the second resistance channels are not provided on the base plate(1005).

By raising the channel resistance of the micro channel or the reading channel(950), or closing the inhaling hole(990) temporally, the speed of the blood can be slowed or the blood can be retained.

### INDUSTRIAL APPLICABILITY

According to the invention, it is possible to examine the blood quickly because the apparatus of the invention can examine a blood type easily by just one injection of a small amount of blood. Such convenient characteristics is useful in case of urgent situations such as in the emergency room, or accident places.

In addition, it is suitable for new-born babies and infants because it needs a quite small amount of blood to examine blood types.

Further, because the reading of the examining result and conservation are easy, it is easy to save the results, has low possibility of writing error, and can be basis for realizing an automatic examination.

Furthermore, it has low risk of infection from outside, and can performs immediately and simultaneously with blood collection.

As above detailed description, although the invention is explained according to preferred embodiments, those skilled in the art can modify and change the invention so long as they are not deviated from the idea and area of the invention.

What is claimed is:

1. A method for examining a blood type by reacting blood with reagents, the method comprising the steps of:
introducing the reagents into the plural reagent storage chambers respectively;
flowing the blood into each of the reagent storage chambers and mixing the blood with the reagents;
filtering the mixture or the agglutination product of the blood and the reagents by micro-filter; and
flowing the mixture or the agglutination product which passed the micro filters into the reading channels connected with the micro-filter.

2. The method according to claim 1, wherein the method further comprises the steps of:
injecting the blood into the blood injection chamber; and
introducing the blood in the blood injection chamber into plural micro-channels, and
wherein the micro-channels are connected with the blood injection chamber, and the blood which passed through the micro-channels is introduced into the reagent storage chamber.

3. The method according to claim 1, wherein at the step of flowing the blood into each of reagent storage chambers and mixing the blood with the reagents,
the end of the reading channel is temporally closed in order to slow the flow speed of the blood so that the blood can be mixed with the reagent for sufficient time.

4. The method according to claim 1, wherein at the step of flowing the mixture or the agglutination product which passed the micro filters into the reading channels:
the end of the reading channel is temporally closed to slow the flow speed of the blood.

5. The method according to claim 1, wherein a reading chamber is formed in the reading channel.

6. The method according to claim 1, wherein a first blood resistance part is formed between the storage chamber and the micro-filter.

7. The method according to claim 6, wherein the first blood resistance part comprises a first resistance channel connecting the storage chamber to the micro-filter and a first hydrophobic surface-processed part which is hydrophobic on at least one portion of inside of the first resistance channel.

8. The method according to claim 6, wherein a second blood resistance part is formed adjacent to the end of the reading channel.

9. The method according to claim 8, wherein the second blood resistance part comprises a second hydrophobic surface-processed part which is hydrophobic on at least one portion of inside of the reading channel.

10. The method according to claim 1, wherein the micro-filter comprises the filter chamber and the filter part which has plural filter poles formed in the filter chamber, the filter part interfering the flow of the blood mixture or agglutination product in the filter.

11. The method according to claim 10, wherein the filter part comprises more than one of filter part located serially with each other, the space interval between the filter poles in the filter part closer to the reagent storage chamber being wider than that between the filter poles in the filter part farther to the reagent storage chamber.

12. The method according to claim 11, wherein the micro-filter comprises a first filter part and a second filter part.

13. An apparatus for examining a blood type comprising: a blood injecting chamber;
plural micro-channels one end of which is connected to the blood injection chamber;
plural reagent storage chambers connected to the other end of the micro-channel;
plural micro-filters connected with reagent storage chambers respectively; and
plural reading channels connected to the micro-filters respectively.

14. The apparatus according to claim 13, wherein:
the micro-channel, the reagent storage chamber, the micro-filter, and the reading channel constitute the reading part by being connected with other so that the injected blood in the blood injection chamber can pass through sequently,
wherein the plural reading parts can be arranged parallel with each other, or symmetrically or radially with respect to the blood injecting chamber.

15. The apparatus according to claim 13, wherein:
the micro-channel connects the blood injecting chamber with the reagent storage chamber one to one.

16. The apparatus according to claim 13, wherein the micro-filter comprises:
the filter chamber; and
the filter part which has plural filter poles formed in the filter chamber, the filter part interfering the flow of the blood mixture or agglutination product in the filter.

17. The apparatus according to claim 16, wherein the width of the filter pole is longer than its length in the cross-sectional view of the filter pole, and the filter poles are allocated crossly to the direction of the fluid which passes through the micro filter.

18. The apparatus according to claim 13, wherein a first blood resistance part is formed between the storage chamber and the micro-filter.

19. The apparatus according to claim 18, wherein the first blood resistance part comprises a first resistance channel connecting the storage chamber to the micro-filter and a first hydrophobic surface-processed part which is hydrophobic on at least one portion of inside of the first resistance channel.

20. The apparatus according to claim 18, wherein a second blood resistance part is formed adjacent to the end of the reading channel.

21. The apparatus according to claim 20, wherein the second blood resistance part comprises a second hydrophobic surface-processed part which is hydrophobic on at least one portion inside of the reading channel.

22. The apparatus according to claim 13, wherein an inhaling hole is formed at the end of the reading channel.

23. The apparatus according to claim 13, wherein the reagents are stored in the reagent storage chamber.

24. The apparatus according to claim 23, wherein the reagents are mixed with a fixing material, and are stored in the reagent storage chamber.

25. An apparatus for examining a blood type comprises:
a base plate;
a chip plate located on the base plate;
a blood injection chamber formed at the chip plate(310);
plural micro-channels formed on the chip plate, and one end on which is connected with blood injection chamber;
plural reagent storage chambers formed on the chip plate, and connected with the other end of the micro-channels;
plural micro filters formed on the chip plate, and connected with the reagent storage chamber;
plural reading channels formed on the chip plate, and connected with the micro-filter; and
reading chambers located on the reading channel, and form a transparent or semi-transparent reading windows,

26. The apparatus according to claim 25, wherein the micro-channel, the reagent storage chamber, the micro-filter, the reading channel, and the reading chamber constitute the reading part by being connected with each other so that the injected blood in the blood infection chamber can pass through sequently,
wherein the plural reading parts can be arranged parallel with each other, or symmetrically or radially with respect to the blood injection chamber.

27. The apparatus according to claim 25, wherein
the chip plate is made from one plastic selected from the group consisting of polymethylmethachrylate(PMMA), polycarbonate, polytetrafluoroethylene (TEFLON), polyvinylchloride(PVC), and polydimethylsiloxane(PDMS), and
the blood injection chamber, the micro-channel, the reagent storage chamber, the micro-filter, the reading channel are formed by being engraved in intaglio at the bottom of the chip plate contacting the base plate.

28. The apparatus according to claim 25, wherein the micro-filter comprises
the filter chamber; and
the filter part which has plural filter poles formed in the filter chamber, the filter part interfering the flow of the blood mixture or agglutination product in the filter.

29. The apparatus according to claim 25, wherein
the filter poles have a cross-section wherein width is longer than its length, and the width and the length are perpendicular in the shape of T, and wherein the filter poles are arrayed regularly with uniform interval with other filter poles.

30. The apparatus according to claim 25, wherein
a first blood resistance part is provided, the first blood resistance part comprising a first resistance channel connecting the storage chamber to the micro-filter and a first hydrophobic surface-processed part which is hydrophobic on bottom of the first resistance channel.

31. The apparatus according to claim 28, wherein
a second blood resistance part is located between one end of the reading channel and the reading chamber, the second blood resistance part comprising a second hydrophobic surface-processed part which is hydrophobic on bottom of the reading channel.

32. The apparatus according to claim 25, wherein
the apparatus comprises an inhaling hole connecting the plural ends of the reading channels into one.

33. In the claim 25, wherein an inhaling hole is formed at the end of each reading channel.

34. The apparatus according to claim 25, wherein the reagents are stored in the reagent storage chamber.
